(19) United States
(12) Patent Application Publication
(10) Pub. No.: US 2015/0356115 A1
(43) Pub. Date: Dec. 10, 2015

(54) Method for Storage and Retrieval of Digital Files

(71) Applicant: Doccle.Up NV, Brussel (BE)

(72) Inventor: Carolus Gerardus Plasman, Brussel (BE)

(21) Appl. No.: 14/654,638

(22) PCT Filed: Dec. 12, 2013
(86) PCT No.: PCT/IB2013/060853

§ 371 Date: Jun. 22, 2015

(30) Foreign Application Priority Data
Dec. 26, 2012 (BE) BE 2012/0879

(51) Int. Cl. G06F 17/30

(52) U.S. Cl. CPC G06F 17/30203

(57) ABSTRACT

Method for storage and retrieval of digital files (200); wherein the method comprises providing one or more sender applications and a platform application (3D). The sender applications are provided with means for generating and storing a set of digital files, wherein the set of digital files is provided with a receiver reference (RRID) associated with a receiver profile. The platform application (3D) is provided with means for receiving an enrolment registration of a user, and further comprises means for verifying the enrolment registration, for producing a verified enrolment profile comprising a user reference (UID). The platform has means for providing a digital connection between the platform application (3D) and any one of the sender applications, with any sender application arranged to provide a list of receiver references (RRID) associated with respective receivers known to the one sender; and means for matching a user's reference (UID) and the receiver references (RRID).

### BACKGROUND OF THE INVENTION

The invention relates to a computer-implemented method for storage and retrieval of digital files. In the prior art, many storage systems are known which are diverse in nature and application possibilities. If a storage system is shared by multiple originating authorities or businesses each creating their own digital files, hereinafter referred to as senders, these storage systems will have sorting functionality to be able to arrange files for a user, so that a user is able to access files in the storage system. In this regard, there exist solutions having users themselves store their information in the Cloud (Cloud services); electronically receiving bills and documents (delivered by email or to be accessed via a server). In the latter case, providers have specific portals to access electronic information or electronic invoices or payments associated with bank accounts. In these cases the sender is obliged to know the electronic delivery identity of the recipient and the user is obliged to obtain a grant of access to these systems. This is often not the case yet or has not yet been communicated by the user.

Customers hence prove not to accept such digital solutions readily because they are different for each provider they deal with. They need to remember their username/password combinations, this is supported with different devices in these environments (mobile or otherwise, or electronic encryption devices are used, for example: eID, etc.). The user interface and functionality differ for each portal that is used. A functionality to deal with documents completely electronically (for contracts, for instance, no digital signing is possible, etc.) is lacking.

Many solutions cannot be used as a filing functionality either, which obliges a user to print documents and store them manually in a filing cabinet. As a consequence, not many users use the digital solutions being offered and most communication still proceeds via paper documents which are sent by traditional post. Businesses and institutions that invest in electronic services do not have the results they expect, while the costs even increase. In fact, on the traditional method, in addition to the investment and exploitation costs of the electronic services, few savings are realized.

In consequence, end users are faced with a number of electronic communication systems of different businesses and institutions that are active to make payments, to deal with their insurance applications or to pay bills or another type of electronic interaction. Such interaction is usually realized by electronic portals which are hosted for these businesses, from where they address the end users and provide them with the necessary user interaction. Although it would be attractive to have a single platform application that provides access to these sender portals designed by the different parties, such a platform application will necessarily need to address interfacing requirements between the different senders and the platform application and soon would not constitute more than another electronic data portal. In addition, to provide a filing functionality for a sender business in a proper manner, it should provide a history of communication that may even precede previous exchange of digital communication for enrolled users of the user platform. Because of the confidential character of the digital communication, certainly where information exchange of strictly private services such as insurances or the like is concerned, a strict access verification is necessary whereby the identity of a user is established.

A problem consists in providing a platform application with a storage function which provides a history of exchanged digital files for a number of users, who do not have a verified enrolment with the platform application yet. The invention has for an object to provide a computer-implemented method for storage and retrieval of digital files which functions for processing digital files in a uniform manner, in particular, the receipt, processing, storage and filing in a digital manner.

There is a need for the provision of a platform application which addresses the above-mentioned problems, and which provides an access to any of the digital files that different senders can offer with an easy and safe storage function for a plurality of senders.

### SUMMARY OF THE INVENTION

In a first aspect, there is provided a computer-implemented method for storage and retrieval of digital files; the method comprising providing one or more sender applications and a platform application. The sender applications are provided with means for generating and storing, for a one sender, a set of digital files for any receiver that is known to the one sender, wherein the set of digital files is provided with a receiver reference (RRID) by the one sender, the receiver reference (RRID) associated with a designated receiver profile and comprising one or more link identifiers (URI) for accessing a digital file in the set of digital files. The platform application is provided with means for receiving an enrolment registration of a user, and further comprises means for verifying the enrolment registration, to produce a verified enrolment profile including a user reference (UID). The platform has means for providing a digital connection between the platform application and any one of the sender applications, the any one sender application arranged to provide a list of receiver references (RRID) associated with designated receivers known to the one sender; means for matching a user's reference (UID) and the receiver references (RRID) provided in the lists provided by any sender application; and means for storing the matched receiver reference (RRID) in the user's enrolment profile.

With the above system, sender applications can preserve a full autonomy over their files. Users no longer need to know their access data for the different associated sender applications. File storage and handling is possible, while via the match mechanism, for enrolled and verified users a complete filing function can be made available in the platform application without use of the enrolment data at the sender applications. This provides a combined overview and easy access to a plurality of associated senders. As such, it will be able to function as a users-oriented digital storage system, which in daily use can provide a filing function for a number of sender applications.

### BRIEF DESCRIPTION OF THE DRAWINGS

These and other features, aspects and advantages of the apparatus, systems and methods of the invention can be understood better from the following description, claims and accompanying drawings, in which:

FIG. 1 shows a first embodiment for a digital connection between a platform application and a sender application;

FIG. 2 shows an alternative embodiment for a digital connection between a platform application and a sender application;

FIG. 3 shows a further embodiment for a digital connection between a platform application and a sender application;

FIG. 4 shows a schematic representation of a user's enrolment profile for digital connection with sender applications; and

FIG. 5 shows a user's enrolment profile with link identifiers for accessing a digital file in the set of digital files of a sender.

### DETAILED DESCRIPTION

Unless indicated otherwise, all terms (including technical and scientific terms) used herein have the same meaning as commonly understood by a person of ordinary skill in the art as he reads this invention in the context of the description and drawings. Further, it will be understood that terms such as they are commonly defined in dictionaries should be interpreted with a meaning that is consistent with the meaning in the context of the relevant prior art and will not be interpreted in an idealized or overly formal manner unless expressly defined as such. In some cases detail descriptions of well known apparatus and methods will be omitted to keep the description of the systems and methods clear.

Terminology that is used for describing particular embodiments is not intended as being limitative of the invention. As used here, the singular forms “a”, and “the” are intended to indicate plural forms, unless the context clearly shows differently. The term “and/or” comprises some or all combinations of one or more that are included in the associated list of items. Further, it will be understood that the terms “comprises” and/or “comprising” indicates the presence of the feature concerned but does not exclude the presence of other features. All publications, patent applications, patents, and other references mentioned herein are incorporated in whole by reference. In case of any conflict the current application, including its definitions, will be decisive.

In an embodiment, the platform application comprises means for selectively making available, by user selection in the enrolment profile, any of link identifiers (URI) in the sender applications that are associated with the receiver references (RRID).

In an embodiment, the platform application comprises means for adding, sorting and deleting the stored link identifiers (URI) associated with the stored receiver references.

In an embodiment, the platform application stores, for an enrolled user, multiple sets of receiver references of any of the sender applications, that are matched with the enrolled user's reference (UID); wherein the link identifiers (URI) contain instructions for selective processing of the digital files, the instruction code managed by any of the sender applications for providing sender specific digital file processing.

In an embodiment, the platform application comprises means for uploading additional sets of digital files uploaded by a user, and wherein the platform application comprises means for adding, sorting and deleting and/or associating the uploaded digital files.

In an embodiment, the receiver reference comprises a user's email address.

In an embodiment, the platform application comprises means for generating a token or set of tokens identifying a receiver reference obtained from a sender after, receiving the list of receiver references (RRID) associated with a designated receiver; wherein the platform application comprises means for contacting a user by the user's email address obtained from the receiver reference; and wherein the user is invited to register to the platform application using the token.

In an embodiment, the platform application comprises means for providing a digital connection with a sender application with a federated identity verification of the verified user profile.

The invention will hereinafter be described more fully with reference to the accompanying drawings, where embodiments of the invention are shown. However, the invention may be embodied in many different embodiments and should not be construed as limited to the embodiments elucidated hereinafter. Rather, these embodiments are provided so that the disclosure is thorough and complete, and will further convey the scope of the invention to the skilled person. The description of example embodiments is intended to be read in conjunction with the accompanying drawings, which are intended as part of the whole description. In the drawings, the dimension and relative dimensions of systems, components, layers and zones may be exaggerated for reasons of clarity. Embodiments are described with reference to schematic illustrations of possibly idealized embodiments and intermediate structures of the implementations.

In the description, relative terms as well as derivatives thereof are to be construed to refer to an orientation as described there in the described drawing shown. These relative terms are for the convenience of the description and do not require that the system be constructed and operated in a particular orientation, unless otherwise indicated. It will be understood that when a particular step or a method is referred to as successive to another step, it can follow that step directly, as well as be carried out after one or more intermediate steps. Also, it is possible that the order is not determined. The same numbers refer to similar elements in the description.

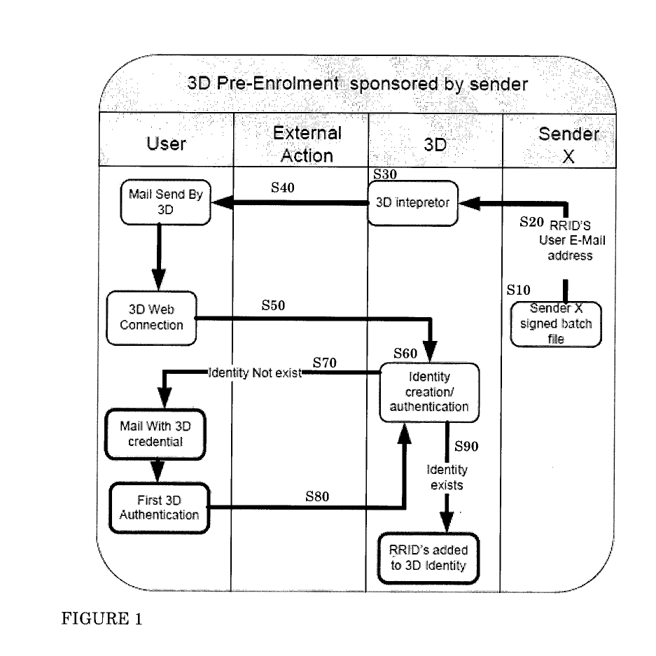

FIG. 1 shows a first embodiment for establishing a digital connection between a platform application (3D) and a sender application. The sender application is an electronic communication system of a respective business or institution that is active, for clients enrolled with the business or institution, to make payments, to deal with their insurance applications, to pay invoices or for another type of electronic interaction. These clients are hereinafter called receivers. The sender applications are provided with means for generating and storing, for a one sender, a set of digital files for receivers that are known to the sender. The set of digital files is provided with a receiver reference (RRID) by the sender, which receiver reference (RRID) is associated with a designed receiver profile and contains one or more link identifiers (URI) for accessing a digital file of the set of digital files.

In a first step S10, a list of receiver references is generated by the sender application.

The receiver references are associated by the sender with a designed receiver profile for receivers known to the sender. These receivers are known to the sender application in that for these receivers services are performed with the aid of the electronic communication systems. The receivers, however, do not need to have an electronic enrolment at the platform application (yet), nor even at the sender application. It suffices that a contact address, for instance, an email address of the receiver is known, to be able to address this receiver. This address does not need to be verified because only in a later stage is the link actually effected, as set out hereinafter.

In the figure it is indicated how a sender application promotes an enrolment registration with the platform application for an existing receiver/client.

To this end, in a second step S20, the list of receiver references is forwarded by the sender application to the platform application 3D. In this embodiment, the receiver reference comprises an address of the client, for example, an email address that can be used for communication with the client. The platform application, upon receipt of the list of receiver references, temporarily stores it in a step S30.

In the embodiment outlined in this figure, the platform application comprises means for generating a token which in a fourth step S40 is sent to a receiver (who is not a user known to the platform application yet), known to the sender, in order to contact the platform application in a step S50. The token identifies the receiver reference which has been temporarily stored at the platform application 3D, upon receipt of the list of receiver references (RRID) from the sender application, in the third step S30. Such a token can link to a system object in the platform application, with the aid of which access control is arranged for the receiver references stored in the platform application, for example, with an identification protocol such as “Secure Assertion Markup Language” (SAML). The message sent in step S40 invites the user to seek access to the platform application in step S50 to register with the platform application.

In this step S50 the user can get access to the platform application 3D which is provided with means for receiving an enrolment registration of a user. To this end, the user can get access to a page whereby the user on the basis of a registered code or other unique identifiable number, can have an enrolment profile created by the platform application in step S60. To this end, it is first of all verified whether the user is not already enrolled. If this is the case, the enrolment profile is associated with the receiver reference in step S90. If this is not the case, however, an access code is forwarded in step S70. The enrolment is verified by checking a unique identifiable code of the user. The platform application stores a hash value of a registered code. This can be done, for instance, with the aid of an HMAC algorithm (known from FIPS PUB 198-1, July 2008), or any other unique identification of the user in step S80.

The hash value is used in the platform application as a global unique identification, which is stored in a secure database and which can be linked to a reference which can serve for a federated identity verification of the verified user profile with other sender applications.

The user can therefore register just once on the platform application in a registration step S60.

After the registration step S60, the enrolment profile can be linked in step S90 to respective receiver references which are temporarily stored at the platform application, i.e., with the aid of the token a linkage is carried out whereby the receiver references of the respective sender application are matched with the user's reference UID of the enrolment profile. After the match has been established, the receiver references have become accessible for the user from the user's enrolment profile, in which these matched receiver references (RRID), are stored, for example, by means of a link. The receiver references (RRID) can then be activated by the user in follow-up steps, and can be activated from the platform application (3D) with the link identifiers (URI) associated with the stored user references, which can establish a link with a respective digital file of the sender application to enable access to the digital file.

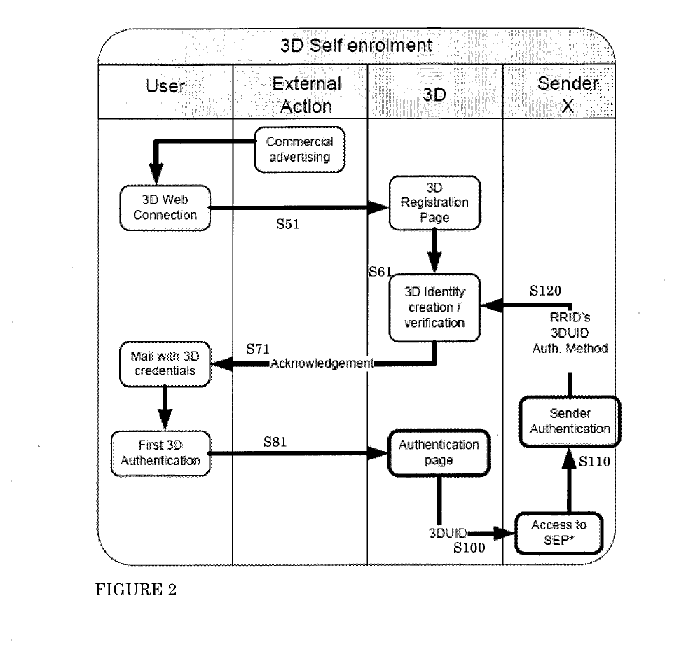

FIG. 2 describes an alternative embodiment for the enrolment registration, in which a user registers directly, without intervention of a sender application X, with the platform application 3D and via a federated identity verification of the verified user's profile is granted access to the set of digital files of a particular sender application X which maintains a digital connection with the platform application 3D. The enrolment registration is done in a manner similar to that indicated in FIG. 1, via the steps S51, S61, S71, S81. The enrolment registration is different from that of FIG. 1 because there is no token known with which receiver references originating from a sender can be identified because these, in contrast with the embodiment of FIG. 1, are not stored in the platform application yet. In the step S51 an interested user, who, for instance via a commercial advertisement, has taken note of the platform application 3D, is given access and the enrolment registration is effected in step 61 (without previously known enrolment registrations). After the access registration the enrolment registration is not activated until an email has been sent to the user, in step S71, with a unique identifiable code, with which, similarly to the embodiment of FIG. 1, in step S81 the user is verified by activating a URL based on this code. In this manner it can be established that the user who performs the enrolment registration is the actual owner of the email address with which a login and passwords can be created.

After the enrolment registration with the platform application 3D has been realized in step S61, the platform application can get access via a digital connection with associated sender applications in a step S100. For this a federated authentication is carried out, which passes on the identity of the user. The user, to that end, comes to a registration page of the sender application X, where he gets access via a first identification token, for instance, via a security protocol as laid down in, for instance, the SAML V.2.0 definition of OASIS. After the user, in step S110, has come to be known to the sender application via an enrolment registration with the sender, the user can be matched with the receiver references RRID, known to the sender application, for the respective user. For that matter, the user does not need to know this receiver reference; linkage to a receiver can be carried out via a pre-shared token set. The sender application X proceeds to link, in step S120, via a second digital connection and a second identification token, to the platform application 3D, whereby the receiver references are passed on and become accessible from the user enrolment profile of the user, in which these matched receiver references (RRID), for instance, by means of a link, are stored similarly to step S90 in the embodiment of FIG. 1.

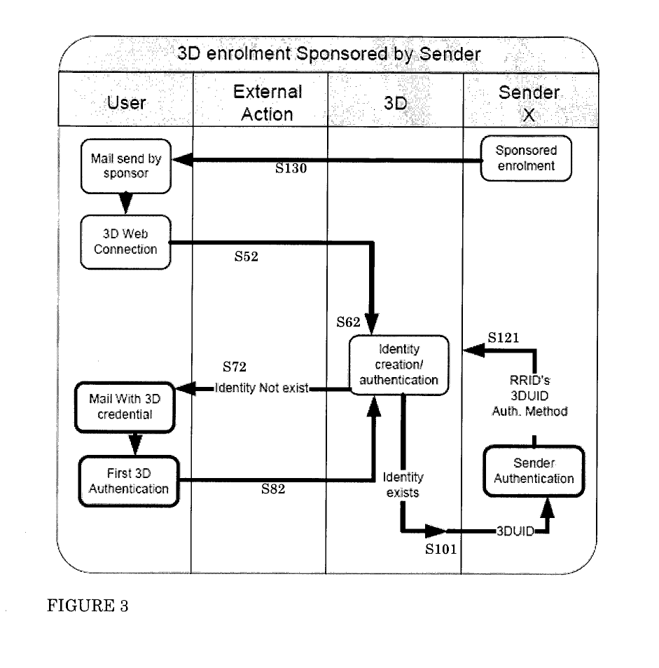

In FIG. 3 a further embodiment for providing a digital connection between the platform application 3D and a sender application X is illustrated. In this case a user, as in the case of FIG. 1, is already known to a sender and enrolled and hence no enrolment registration with the sender application X needs to be done anymore, in contrast to FIG. 2. The sender application X sends a registered user an email in step S130, and the user seeks contact with the platform application in a manner similar to that in FIG. 2 via steps S52, S72 and S82, in which last steps the user is verified as actual owner of the email address with which a login and passwords the platform application is accessed. If thereupon these steps have been completed, a federated authentication is carried out, which passes on the identity of the user via an identification token in step S101. Since the user is registered with the sender application X, he is matched with the receiver references RRID known at the sender application for the user concerned. The sender application X proceeds in step S121 to link, via a second digital connection and a second identification token, to the platform application 3D, in which these matched receiver references (RRID), for instance by means of a link, are stored in the user enrolment profile of the user, similarly to step S90 in the embodiment of FIG. 1.

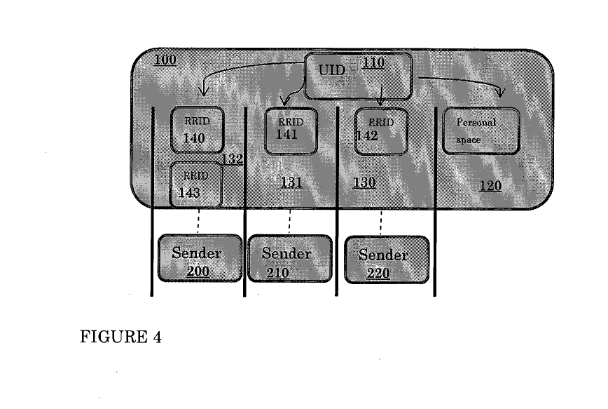

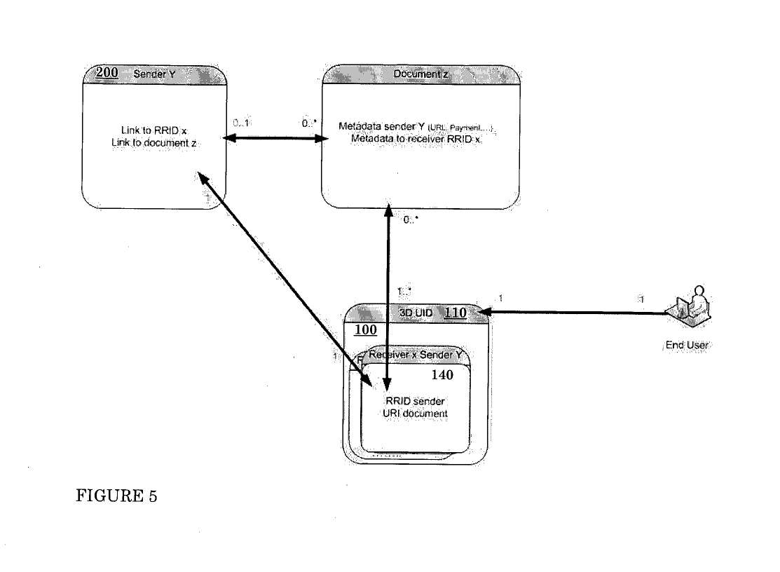

FIG. 4 schematically shows a user's enrolment profile 110 of a platform application 100, which provides a file access with associated receiver references 140-142 of multiple sender applications 200-220. From the figure it appears that in the user's profile 110, which is identified via the unique user's reference UID and is associated with receiver references (RRID), are stored by means of a link. The receiver references 140-143 associated with the user's profile 110 designed for the user contain one or more link identifiers (URI) for accessing a digital file of the set of digital files of the respective sender applications 200-220, as is further elucidated with reference to FIG. 5. The sender applications 200-220 have only access to their own digital files that are available within one silo 130-132 in the platform application 100. These silos are therefore program functionalities for providing a digital connection between the platform application and the sender applications, via the above-outlined manners of connection, the sender applications 200-220 being arranged for providing a list of receiver references (RRID) which is associated with the respective user. The user, known as receiver to diverse sender applications 200-220, can access these digital files linked to the receiver reference RRID, via the user's enrolment profile 110. The platform application has means for adding, sorting and deleting the link identifiers (URI), stored after match, so that the user himself is able to preserve and file what is of interest to him. Further provided in the platform application 100 are means 120 for uploading additional sets of digital files uploaded by a user. Such a means 120 can be seen as a silo for personal file storage for digital files. This storage can be provided with a separate user access and identification, which can be used separately from the sender additions. These personal files can be associated with other files, in particular, the files made accessible via the senders 200-220.

FIG. 5 shows in more detail the receiver reference 140 of a user profile 100 in a further elaboration for accessing a digital file Z at a sender application 200. This is done by activation of earlier-mentioned link identifiers which can load the document to the platform application directly, or indirectly via the sender application 200. The sender application 200 can arrange that this removal can be undone in that the files are not physically removed but merely the link to the files becomes inactive. The link identifier may then also indicate a file type indication and is typically generally suitable to identify a file or a source via a network, as well as the means to access and process the file or the source. The file type indication can be linked to instructions for selective processing of the digital files that are accessed by the user. The instruction code can be managed by the sender application to provide sender specific digital file processing without the sender having to choose between predefined document types. It is, after all, a problem that predefined general document types cannot service all senders from diverse sectors equally well. That is why there is a need for document types that are fully determined by the sender and where the platform application allows a document type-specific processing. With this, the advantage is achieved that as yet unknown and any kinds of documents can be managed and processed with the aid of the user profile from the platform application.

What the platform application allows, therefore, is to have the sender himself fully determine the document type (and the associated handling instructions) and yet to allow a uniform method over different senders. The instruction code of the sender application determines what handling instructions or “actions” can be linked to the digital file. That is why sender specific processing is possible in that senders themselves can create document types. Further, the platform application 100 can provide for defining that files of a particular file type are stored in a fixed environments and obtain standard labels for rapid retrieval/filtering of digital files. This can be done by updating the metadata associated to the file.

The different elements of the embodiments as described and shown herein have different advantages. Obviously, it needs to be understood that any of the above-mentioned embodiments or processes can be combined with any of the embodiments or processes to provide further improvements by finding and matching of designs and advantages. In the description it has been set out how a single receiver reference of a sender is matched with a user's reference originating from a single user. It is possible that multiple users or multiple senders are involved, while the principles apply similarly and, for instance, a receiver reference associated in a user profile is linked to multiple senders.

Finally, the above-mentioned discussion is intended to be illustrative only of the current system and the claims should not be limited to a particular embodiment or group of embodiments. While the current method is described in particular detail with reference to a specific embodiment, it should also be understood that various modifications and alternative embodiments can be provided by the skilled person without deviating from the scope of the current systems and methods as described in the following claims. The description and drawings are therefore to be taken as illustrative and are not intended to limit the scope of the claims.

In interpreting the claims it should be understood that reference numerals in the claims do not limit their scope, different means can be denoted by the same item or implemented structure or function; and any of the disclosed apparatuses, or parts thereof, unless specifically indicated otherwise. The mere fact that certain features are recited in mutually different claims does not mean that a combination of these features could not be used with advantage.

1. A computer-implemented method (A) for storage and retrieval of digital files (200), the method comprising
providing one or more sender applications; the sender applications having means for generating and storing, for a one sender, a set of digital files for any receiver that is known to the one sender, wherein the set of digital files is provided with a receiver reference (RRID) by the one sender, said receiver reference (RRID) associated with a designated receiver profile and comprising one or more link identifiers (URI) for accessing a digital file in the set of digital files;
providing a platform application having means for receiving an enrolment registration of a user;
the platform application further comprising means for verifying the enrolment registration to produce a verified enrolment profile including a user reference (UID);
means for providing a digital connection between the platform application and any one of the sender applications, said any one sender application arranged to provide a list of receiver references (RRID) associated with designated receivers known to the one sender;
means for matching a user's reference (UID) to the receiver references (RRID) provided in the lists provided by any sender application; and
means for storing matched receiver references (RRID) to the users' enrolment profile.

2. The computer-implemented method (A) according to claim 1, wherein said platform application comprises means for selectively making available, by user selection in said enrolment profile, any of link identifiers (URI) in the sender applications that are associated with the receiver references (RRID).

3. The computer-implemented method (A) according to claim 1, wherein said platform application comprises means for adding, sorting and deleting stored link identifiers (URI) associated with the stored receiver references (RRID).

4. The computer-implemented method (A) according to claim 1, wherein the platform application stores, for an enrolled user, multiple sets of receiver references (RRID) of any of the sender applications, that are matched with said enrolled user's reference (UID); wherein the link identifiers (URI) contain instruction code for selective processing of said digital files, said instruction code managed by any of said sender applications for providing sender specific digital file processing.

5. The computer-implemented method (A) according to claim 1, wherein the platform application comprises means for uploading additional sets of digital files uploaded by a user, and wherein the platform application comprises means for adding, sorting and deleting and/or associating said uploaded digital files.

6. The computer-implemented method (A) according to claim 1, wherein the receiver reference contains a user's email address.

7. The computer-implemented method (A) according to claim 6, wherein the platform application comprises means to generate a token identifying a receiver reference obtained from a sender after receiving a list of receiver references (RRID), associated with a designated receiver; wherein the platform application comprises means to contact a user by the user's email address obtained from the receiver reference; and wherein the user is invited to register to the platform application using said token.

8. The computer-implemented method (A) according to claim 1, wherein the platform application comprises means for providing a digital connection with a sender application with federated identity verification of said verified enrolment profile.
